(19) United States
(12) Patent Application Publication
(10) Pub. No.: US 2026/0184999 A1
(43) Pub. Date: Jul. 2, 2026

(54) OIL SYNTHESIS DEVICE AND OIL SYNTHESIS METHOD

(71) Applicant: OONO DEVELOPMENT CO., LTD, Matsuyama-shi, Ehime (JP)

(72) Inventors: Shinfuku NOMURA, Matsuyama-shi, Ehime (JP); Akihiro KAKUBO, Matsuyama-shi, Ehime (JP); Ryota SHIBA, Matsuyama-shi, Ehime (JP); Ryo SHIMIZU, Toon-shi, Ehime (JP); Junichi NAKAJIMA, Matsuyama-shi, Ehime (JP); Teruo HENMI, Matsuyama-shi, Ehime (JP)

(21) Appl. No.: 19/131,286

(22) PCT Filed: Nov. 20, 2023
(86) PCT No.: PCT/JP2023/041611

§ 371 Date: May 20, 2025

(30) Foreign Application Priority Data
Nov. 21, 2022 (JP) 2022-185688

(51) Int. Cl. C10G 2/00; B01J 19/00; B01J 19/08

(52) U.S. Cl. CPC C10G 2/50; B01J 19/0013; B01J 19/088; B01J 2219/00121; B01J 2219/0809; B01J 2219/0815; B01J 2219/0877; B01J 2219/0884; B01J 2219/0896

(57) ABSTRACT

An oil synthesis device comprises an electrode holding unit that can hold therein an electrode unit capable of generating plasma in a starting material liquid derived from both carbon dioxide and water and that is kept at ambient temperature and ambient pressure, wherein the oil synthesis device is capable of synthesizing an oil by the plasma from the starting material liquid located in the electrode holding unit.

### DESCRIPTION

### Technical Field

The present invention relates to an oil synthesis device and an oil synthesis method.

### Background Art

In recent years, it has been reported that global warming is rapidly progressing due to the influence of greenhouse gases such as carbon dioxide. In response to this, in October 2020, the Japanese government declared to aim for “carbon neutral” to reduce greenhouse gas emissions to 0 as a whole by 2050. To realize “carbon neutral”, attempts have been made to effectively utilize emitted carbon dioxide in addition to suppression of emission of greenhouse gases, especially carbon dioxide, which accounts for a high proportion.

Along with this, attention has been paid again to a method for synthesizing methane, which can be used as a fuel gas, from carbon dioxide and hydrogen under high temperature and high pressure conditions using a catalyst (the Sabatier process) and a method for synthesizing a liquid hydrocarbon compound, which can be used as an oil, from carbon monoxide and hydrogen in coal gas (the FT process).

### PRIOR ART DOCUMENTS

### Patent Documents

Patent Document 1: JP-A-2022-108779
Patent Document 2: JP-A-2022-102703
Patent Document 3: JP-A-2019-116402

### SUMMARY OF THE INVENTION

### Problems to be Solved by the Invention

Here, it has been found that when an oil is synthesized by utilizing carbon dioxide on the basis of these synthesis methods, since hydrogen or the like is used in combination under a high temperature and high pressure condition in a synthesis device, energy efficiency during operation of the device is lowered, and there is also a risk of explosion during operation.

Thus, an object of the present invention is to provide an oil synthesis device and an oil synthesis method capable of improving energy efficiency and securing safety for oil synthesis utilizing carbon dioxide.

### SOLUTIONS TO THE PROBLEMS

To achieve the above object, in one embodiment of the present invention,
there is provided an oil synthesis device comprising an electrode holding unit that can hold therein an electrode unit capable of generating plasma in a starting material liquid derived from both carbon dioxide and water and that is kept at ambient temperature and ambient pressure, wherein the oil synthesis device is capable of synthesizing an oil by the plasma from the starting material liquid located in the electrode holding unit.

In addition, to achieve the above object, in one embodiment of the present invention,
there is provided a method for synthesizing an oil, comprising applying a voltage to an electrode unit in an electrode holding unit that can hold therein the electrode unit and that is kept at ambient temperature and ambient pressure, thereby generating plasma in a starting material liquid derived from both carbon dioxide and water located in the electrode holding unit, and thereby synthesizing the oil from the starting material liquid.

### Effects of the Invention

According to one embodiment of the present invention, it is possible to suitably synthesize an oil utilizing carbon dioxide by an oil synthesis device with improved energy efficiency and ensured safety.

### BRIEF DESCRIPTION OF THE DRAWINGS

FIG. 1 is a sectional diagram schematically illustrating an aspect of synthesizing an oil utilizing carbon dioxide by an oil synthesis device according to one embodiment of the present invention.

FIG. 2 is a sectional view schematically illustrating the configuration of an oil synthesis device according to one embodiment of the present invention.

FIG. 3 is a chromatogram in Example 1 (Measurement No. 1).

FIG. 4 is a chromatogram in Example 1 (Measurement No. 2).

FIG. 5 is a chromatogram in Example 1 (Measurement No. 3).

FIG. 6 is a chromatogram in Example 2 (Measurement No. 4/plasma treatment time: 30 minutes).

FIG. 7 is a chromatogram in Example 2 (Measurement No. 4/plasma treatment time: 60 minutes).

FIG. 8 is a chromatogram in Example 2 (Measurement No. 4/plasma treatment time: 0 minutes).

FIG. 9 is a chromatogram in Example 2 (Measurement No. 5/plasma treatment time: 30 minutes).

FIG. 10 is a chromatogram in Example 2 (Measurement No. 5/plasma treatment time: 60 minutes).

FIG. 11 is a chromatogram in Example 2 (Measurement No. 5/plasma treatment time: 0 minutes).

FIG. 12 is a chromatogram in Example 2 (Measurement No. 6/plasma treatment time: 1 minute).

FIG. 13 is a chromatogram in Example 2 (Measurement No. 6/plasma treatment time: 2 minutes).

FIG. 14 is a chromatogram in Example 2 (Measurement No. 6/plasma treatment time: 5 minutes).

FIG. 15 is a chromatogram in Example 2 (Measurement No. 6/plasma treatment time: 30 minutes).

FIG. 16 is a chromatogram in Example 2 (Measurement No. 6/plasma treatment time: 60 minutes).

FIG. 17 is a chromatogram in Example 2 (Measurement No. 6/plasma treatment time: 0 minutes).

FIG. 18 is a chromatogram in Example 3 (Measurement No. 7/plasma treatment time: 30 minutes).

FIG. 19 is a chromatogram in Example 3 (Measurement No. 7/plasma treatment time: 60 minutes).

FIG. 20 is a chromatogram in Example 3 (Measurement No. 7/plasma treatment time: 0 minutes).

FIG. 21 is a chromatogram in Example 4 (Measurement No. 8/plasma treatment time: 30 minutes).

FIG. 22 is a chromatogram in Example 4 (Measurement No. 8/plasma treatment time: 60 minutes).

FIG. 23 is a chromatogram in Example 4 (Measurement No. 8/plasma treatment time: 0 minutes).

FIG. 24 is a chromatogram in Comparative Example 1 (Measurement No. 9/reaction time in electrode holding unit: 60 minutes (without performing plasma treatment)).

FIG. 25 is a chromatogram in Comparative Example 1 (Measurement No. 9/reaction time in electrode holding unit: 0 minutes (without performing plasma treatment)).

### DETAILED DESCRIPTION

Hereinafter, an oil synthesis device according to one embodiment of the present invention will be described with reference to drawings.

As a result of repeated studies from a new viewpoint instead of the extension of the prior art, the inventors of the present application have devised to adopt a technique of “in-liquid plasma” for generating plasma in a liquid to an oil synthesis device for synthesizing an oil utilizing carbon dioxide.

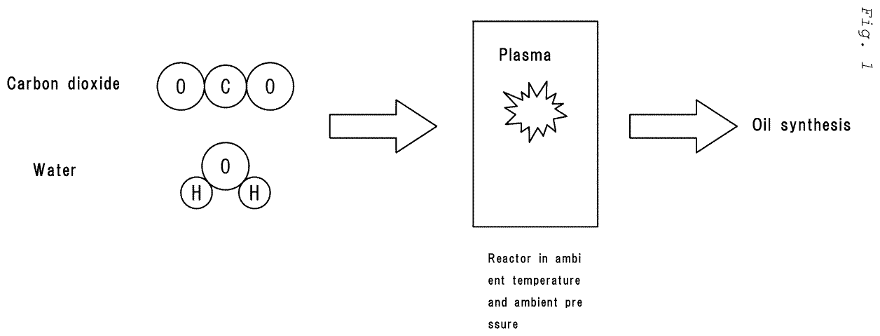

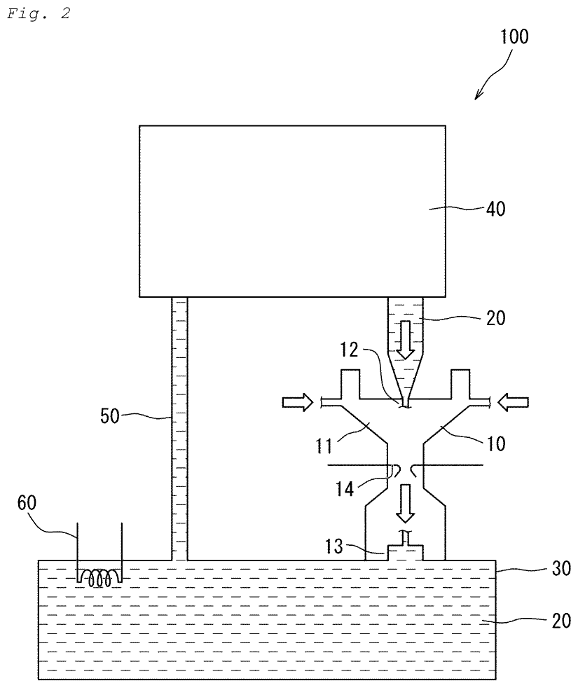

Specifically, an oil synthesis device 100 according to one embodiment of the present invention includes an electrode holding unit 10 that can hold an electrode unit 14 therein and that is kept at ambient temperature and ambient pressure (see FIGS. 1 and 2). Further, a starting material liquid 20 derived from both carbon dioxide and water is located in the electrode holding unit 10, and the electrode unit 14 can generate plasma in the starting material liquid 20. As the electrode holding unit 10, a reactor in which an electrode unit as shown in FIG. 2 can be disposed, a glass container into which an electrode unit (corresponding to two electrodes) can be inserted, or the like can be used.

The electrode unit 14 is electrically connected to a power supply, and can apply a voltage using the power supply. The electrode unit 14 includes a positive electrode and a negative electrode, and is configured to generate plasma in the starting material liquid 20 in a state where a voltage is applied between the positive electrode and the negative electrode.

The constituent materials of the electrodes each may be a W-based material.

The inter-electrode distance in the electrode unit 14 may be, for example, 0.5 mm or more and 10 mm or less, and may be preferably 1 mm or more and 7 mm or less, more preferably 2 mm or more and 4 mm or less, for example, 3 mm.

As the starting material liquid 20, at least one selected from the group consisting of an aqueous alkali metal carbonate solution using carbon dioxide, an aqueous alkaline earth metal carbonate solution, and a gaseous carbon dioxide dissolved solution can be used. The aqueous alkali metal carbonate solution and the aqueous alkaline earth metal carbonate solution each can be obtained by dissolving carbon dioxide in a basic solution (for example, aqueous sodium hydroxide solution) having a characteristic of easily absorbing carbon dioxide to form a carbonate, and dissolving the carbonate in water.

The gaseous carbon dioxide dissolved liquid can be obtained by blowing gaseous carbon dioxide into pure water to dissolve the gaseous carbon dioxide. Since this solution contains gaseous carbon dioxide, it can also be referred to as a gaseous carbon-dioxide-containing liquid. As an aspect of forming the starting material liquid using gaseous carbon dioxide, for example, there is a pattern of forming the starting material liquid while continuously blowing gaseous carbon dioxide into water that can be located in the electrode holding unit 10. That is, at least one of the atmosphere and carbon dioxide (specifically, gaseous carbon dioxide) can be supplied into the electrode holding unit 10. Alternatively, the aspect of forming the starting material liquid using gaseous carbon dioxide may be a pattern of forming the starting material liquid by blowing gaseous carbon dioxide into water in advance outside the system of the electrode holding unit 10.

For example, a sodium carbonate solution can be used as the starting material liquid 20. In this case, the sodium carbonate solution is obtained by dissolving carbon dioxide in a basic solution (for example, an aqueous sodium hydroxide solution) having a characteristic of easily absorbing carbon dioxide to form sodium carbonate, and dissolving the sodium carbonate in water.

In one embodiment, the starting material liquid 20 can continuously pass through a region where plasma is generated in the electrode holding unit 10. As described above, since the electrode unit 14 in the starting material liquid 20 is a member capable of generating plasma, specifically, the starting material liquid 20 can continuously pass through the electrode unit 14, specifically, a region between the positive electrode and the negative electrode. To pass and supply the starting material liquid 20, the electrode holding unit 10 has therein a passage extending the installation region of the electrode unit 14.

From this fact, the type of supplying the starting material liquid 20 into the electrode holding unit 10 may be a continuous type. In this regard, in the conventional in-liquid plasma treatment, a batch type in which a starting material liquid is charged in advance in a reaction vessel is the main type, and in this respect, the type of supplying the starting material liquid 20 can be characteristic.

To realize the continuous supply of the starting material liquid 20, the oil synthesis device 100 further includes, in addition to the electrode holding unit 10 described above, a starting material liquid holding unit 30, a pump unit 40, a connection pipe 50 connecting these components, and a cooling unit 60 capable of cooling the starting material liquid 20 in the starting material liquid holding unit 30.

By using the cooling unit 60, it is possible to suppress the temperature of the starting material liquid 20 from being increased by the energy of the plasma, and the synthesized low molecular weight organic component from being volatilized and lost.

Specifically, the electrode holding unit 10, the starting material liquid holding unit 30, and the pump unit 40 can be disposed such that the starting material liquid 20 circulates through these components via the connection pipe 50. With such a disposition, the electrode holding unit 10 and the starting material liquid holding unit 30 can be connected to each other via the pump unit 40 in such a manner that the starting material liquid 20 can repeatedly pass in one direction through the electrode holding unit 10.

In addition, the electrode holding unit 10 includes a main body part 11, an inflow part 12 for the starting material liquid 20 disposed on one side of the main body part 11 in the longitudinal extending direction of the main body part 11, and an outflow part 13 disposed on the other side thereof.

With the above configuration, in the present invention, in the electrode holding unit 10 that can hold the electrode unit 14 therein and that is kept at ambient temperature and ambient pressure, a voltage is applied to the electrode unit 14 to generate plasma in the starting material liquid 20 derived from both carbon dioxide and water that can be located in the electrode holding unit 10. Specifically, in the present invention, the starting material liquid 20 can pass in one direction through a region where plasma is generated in the electrode holding unit 10. In the present invention, such plasma makes it possible to combine at least a carbon source and a hydrogen source (more specifically, also an oxygen source in addition to the carbon source and the hydrogen source) contained in the starting material liquid 20, and this makes it possible to synthesize an oil.

In this regard, the conventional in-liquid plasma treatment mainly includes an aspect in which bonds between a carbon source and a hydrogen source or the like are broken, whereas the present invention is different in that a carbon source and a hydrogen source or the like can be bonded. Therefore, the fact that in the in-liquid plasma treatment in the present invention, it has become possible to form a bond of a carbon source with a hydrogen source and the like for oil synthesis is per se of technical significance.

Examples of the synthesizable oil (a bonded product of a carbon source, a hydrogen source, and an oxygen source) include alcohol and acetone. The alcohol may be, for example, ethanol. The term “oil” used herein refers to a compound containing a hydrocarbon and oxygen.

As described above, in the present invention, since a starting material liquid having no risk of explosion at ambient temperature and ambient pressure (s sodium carbonate solution) is used in the synthesis of an oil utilizing carbon dioxide, it is possible to improve the energy efficiency and secure the safety during the operation of the synthesis device as compared with an aspect in which hydrogen is used in combination under a conventional high-temperature and high-pressure condition.

In addition, in the present invention, the use of a catalyst is not essential, that is, no catalyst may be present in the electrode holding unit 10, as compared with a conventional aspect in which the use of a catalyst is essential in the synthesis of an oil or the like.

In the present invention, in a plasma generation region, the starting material liquid 20 may be kept in contact with the plasma for 1 minute or more and 60 minutes or less, preferably 1 minute or more and 10 minutes or less, and more preferably 3 minutes or more and 8 minutes or less, for example, for 5 minutes.

Preferably, from the viewpoint of promoting the plasma treatment of the starting material liquid 20, the electrode holding unit 10 is configured to be able to spray the mist of the starting material liquid toward the plasma generation region. Specifically, in the electrode holding unit 10, the inflow part 12 for the starting material liquid can be tapered toward the main body part 11.

From the viewpoint of increasing the carbon source and the oxygen source in the starting material liquid 20 to be subjected to the plasma treatment, at least one of the atmosphere and carbon dioxide can be additionally supplied into the electrode holding unit 10.

In an aspect in which the atmosphere is additionally supplied into the electrode holding unit 10, carbon dioxide itself contained in the air may be treated by the oil synthesis device 100 of the present invention. That is, the aspect of additional supply of the atmosphere into the electrode holding unit 10 also has a technical feature in that so-called direct air capture (DAC) processing can be performed.

### Examples

Hereinafter, examples of the present invention will be described.

### Example 1

In Example 1, the following contents were performed three times in total on different days. Hereinafter, the contents of implementation will be described.

### (Configuration of Oil Synthesis Device)

An oil synthesis device having the following components was used.
Electrode holding unit 10 (used at room temperature+atmospheric pressure)
   Main body part 11 (material: PTFE, with additional supply port for the atmosphere/carbon dioxide (supply port diameter: φ1 mm))
   Inflow part 12 for starting material liquid (material: PTFE, inflow diameter: R3/4 (20 A))
   electrode unit 14 positioned in main body part 11 (material: tungsten, inter-electrode distance: 3 mm)
Starting material liquid 20

Sodium carbonate solution (obtained by dissolving 1.5 g/L of a sodium carbonate reagent in 4 L of pure water)

Sodium carbonate reagent: special grade reagent 99.8%, manufactured by FUJIFILM Wako Pure Chemical Corporation
Starting material liquid holding unit 30

Tank capable of holding the sodium carbonate solution.
Pump unit 40

Pump NF3-250S with a flow rate of 28 L/min, manufactured by Kawamoto Pump Mfg. Co., Ltd.
Connection pipe 50

Material: PVC blade hose, diameter: φ19×φ26 mm
Power supply

High-frequency pulse power supply (MPP04-A4-200-A manufactured by Kurita Manufacturing Co., Ltd.), AC pulse ±4 kV, duty ratio: 10% (0.5 μs), frequency: 200 kHz, power consumption: 1000 W)
Cooling unit 60

Immersion cooler

### (Cooling of Sodium Carbonate Solution in Tank+Additional Supply of Carbon Dioxide to Electrode Holding Unit)

With the sodium carbonate solution in the tank cooled to 10° C. using the cooler 60, the sodium carbonate solution in the tank was continuously supplied with a pump into the electrode holding unit 10 kept at ambient temperature and ambient pressure. At the time of the continuous supply into the electrode holding unit 10, carbon dioxide was additionally supplied through the additional supply port of the electrode holding unit 10 at a rate of 80 mL/min.

### (Plasma Treatment)

Then, the sodium carbonate solution was made to flow such that the solution passed through a passage extending through the installation region of the electrode unit 14 in the electrode holding unit 10. In this state, a voltage was applied to the electrode unit 14 using the pulse power supply, whereby plasma was generated in the sodium carbonate solution. The plasma treatment time was 60 minutes.

### (Measurement)

Thereafter, the solution subjected to the plasma treatment was returned to the tank, and the solution (containing a sodium carbonate solution as a starting material liquid) subjected to the plasma treatment in the tank was sampled, and subjected to quantitative analysis and qualitative analysis using a gas chromatography mass spectrometer (GC-MS-QP2010 Ultra manufactured by Shimadzu Corporation). Various conditions such as a column used at the time of the analysis were as follows.
Column used: DB-FFAP (polar column)
Analytical amount: 1 μL
Split ratio: 1:10
Number of washings: once before measurement and once after measurement
Number of rinsings: twice

### (Results (Three Times in Total))

Measurement result 1

As shown in FIG. 3, acetone (74.84 mg/L) and ethanol (834 mg/L) were found to be present in the solution subjected to the plasma treatment. The temperature on the day when the plasma treatment was performed was 14.3° C.
Measurement result 2

As shown in FIG. 4, acetone (57.84 mg/L) and ethanol (97.73 mg/L) were found to be present in the solution subjected to the plasma treatment. The temperature on the day when the plasma treatment was performed was 20.7° C.
Measurement result 3

As shown in FIG. 5, acetone (98.98 mg/L) and ethanol (96.64 mg/L) were found to be present in the solution subjected to the plasma treatment. The temperature on the day when the plasma treatment was performed was 21.1° C.

### Example 2

In Example 2, for Example 1 described above, the presence or absence of oil detection and the detection concentration in the treatment solution due to the difference in plasma treatment time were measured. The measurement was performed on different days three times in total. Since the measurement conditions and the like were the same as those related to Example 1, a specific description thereof is omitted in order to avoid duplication of description.

### (Results (Three Times in Total))

Measurement result 4

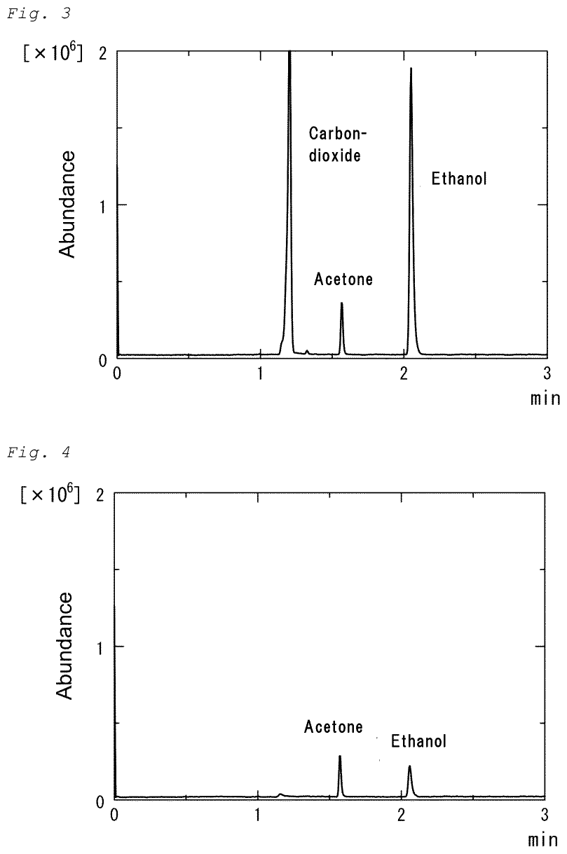

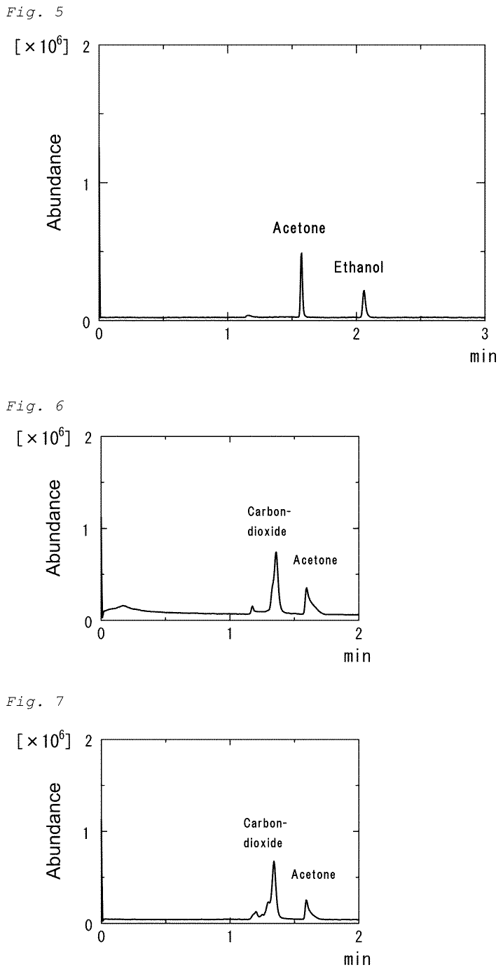

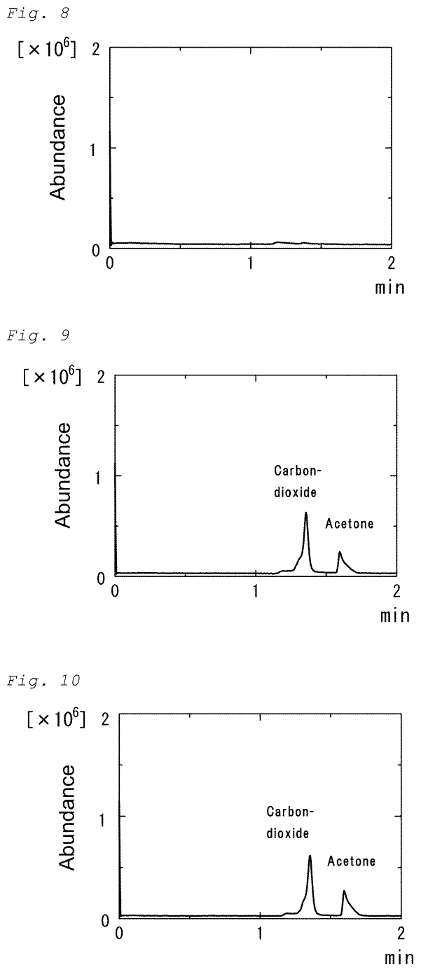

As shown in FIGS. 6 and 7, it was found that acetone (49.31 mg/L) was present in the solution after the plasma treatment was performed for 30 minutes, and acetone (35.34 mg/L) was present in the solution after the plasma treatment was performed for 60 minutes. The temperature on the day when the plasma treatment was performed was 25.3° C. When the plasma treatment was not performed, oil components such as acetone were not detected as shown in FIG. 8.
Measurement result 5

As shown in FIGS. 9 and 10, it was found that acetone (34.25 mg/L) was present in the solution after the plasma treatment was performed for 30 minutes, and acetone (38.02 mg/L) was present in the solution after the plasma treatment was performed for 60 minutes. The temperature on the day when the plasma treatment was performed was 24.8° C. When the plasma treatment was not performed, oil components such as acetone were not detected as shown in FIG. 11.
Measurement result 6

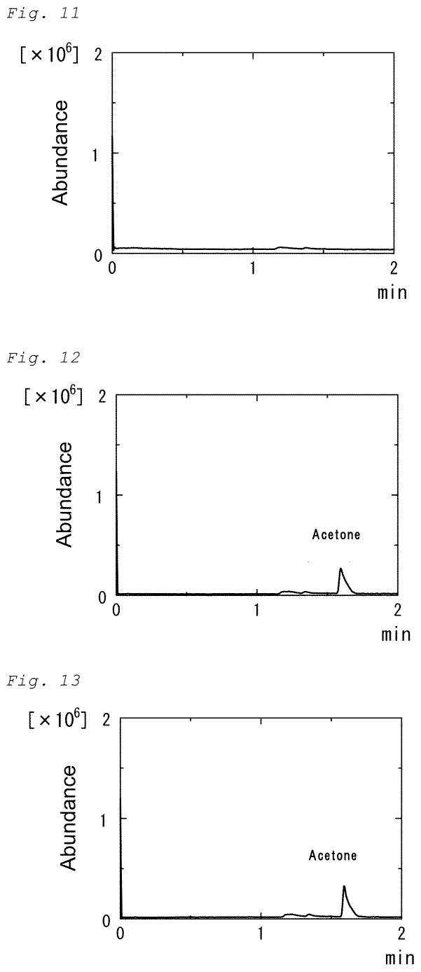

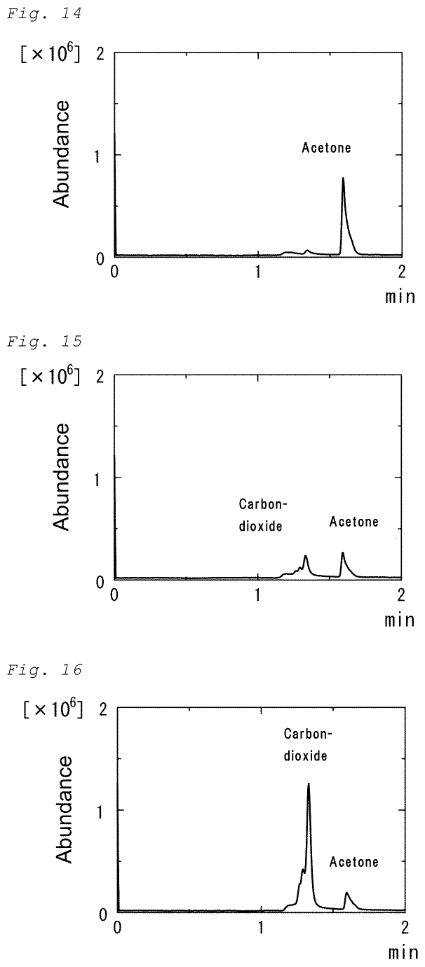

As shown in FIGS. 12 to 16, it was found that acetone (37.65 mg/L) was present in the solution after the plasma treatment was performed for 1 minute, acetone (45.72 mg/L) was present in the solution after the plasma treatment was performed for 2 minutes, acetone (108.02 mg/L) was present in the solution after the plasma treatment was performed for 5 minutes, acetone (37.70 mg/L) was present in the solution after the plasma treatment was performed for 30 minutes, and acetone (27.41 mg/L) was present in the solution after the plasma treatment was performed for 60 minutes. The temperature on the day when the plasma treatment was performed was 27.1° C. When the plasma treatment was not performed, oil components such as acetone were not detected as shown in FIG. 17.

### Example 3

In Example 3, the “cooling of the sodium carbonate solution in the tank” in Example 1 was not performed, but the plasma treatment was performed under the supply of the atmosphere to the electrode holding unit. Since the measurement conditions and the like were the same as those related to Example 1, a specific description thereof is omitted in order to avoid duplication of description.

### (Results)

Measurement result 7

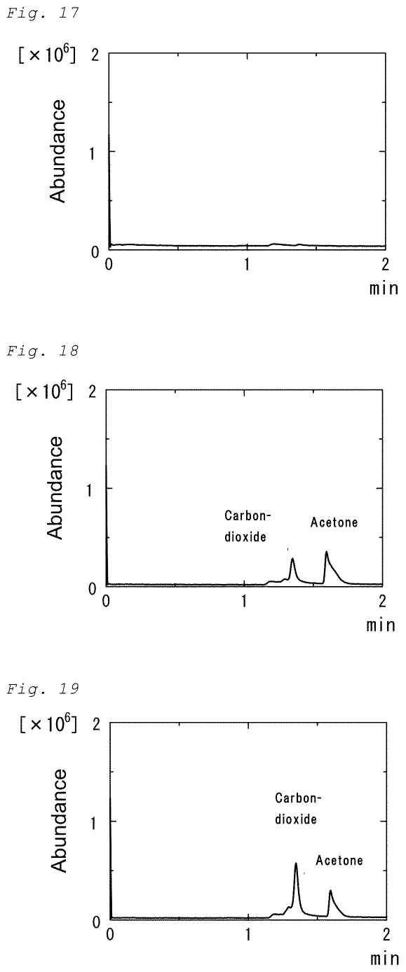

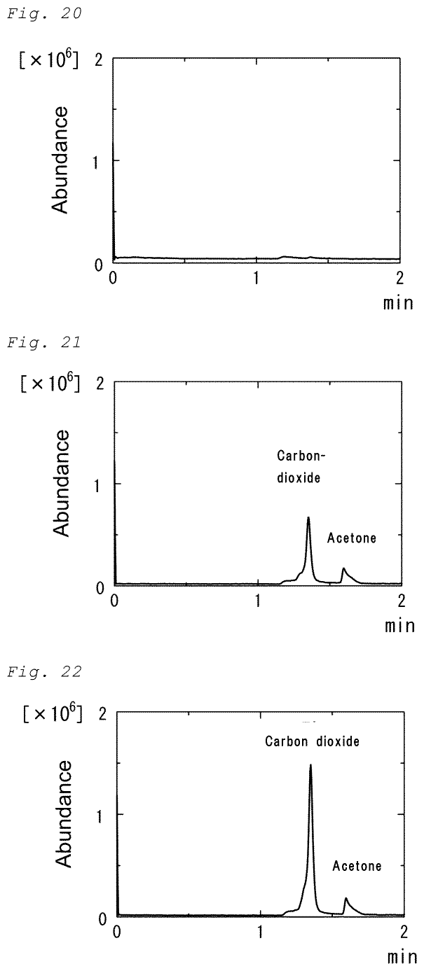

As shown in FIGS. 18 and 19, it was found that acetone (50.06 mg/L) was present in the solution after the plasma treatment was performed for 30 minutes, and acetone (42.06 mg/L) was present in the solution after the plasma treatment was performed for 60 minutes. The temperature on the day when the plasma treatment was performed was 25.8° C. When the plasma treatment was not performed, oil components such as acetone were not detected as shown in FIG. 20.

### Example 4

In Example 4, the “cooling of the sodium carbonate solution in the tank” in Example 1 was not performed, and “additional supply of carbon dioxide to the electrode holding unit” was performed. Since the measurement conditions and the like were the same as those related to Example 1, a specific description thereof is omitted in order to avoid duplication of description.

### (Results)

Measurement result 8

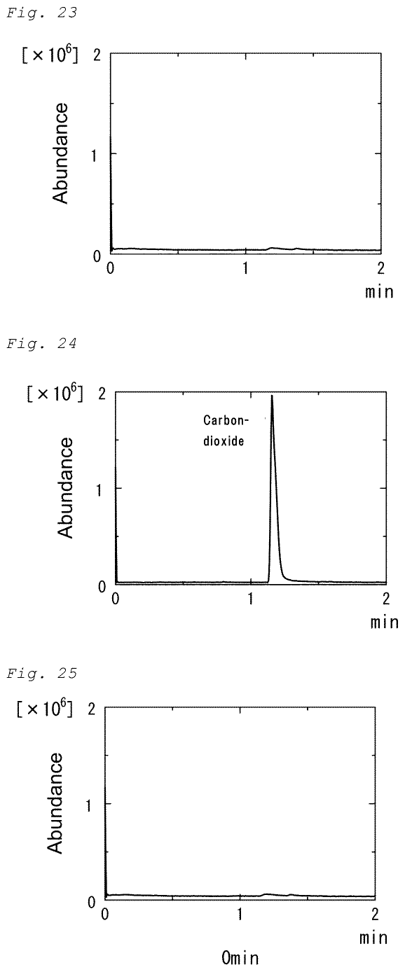

As shown in FIGS. 21 and 22, it was found that acetone (24.06 mg/L) was present in the solution after the plasma treatment was performed for 30 minutes, and acetone (25.75 mg/L) was present in the solution after the plasma treatment was performed for 60 minutes. The temperature on the day when the plasma treatment was performed was 24.9° C. When the plasma treatment was not performed, oil components such as acetone were not detected as shown in FIG. 23.

### Comparative Example 1

In Comparative Example 1, the “plasma treatment” was not performed and the “additional supply of carbon dioxide to the electrode holding unit” was performed as compared with Example 1 described above. Specifically, in the configuration of the oil synthesis device used, the power supply and the electrode unit 14 in the electrode holding unit 10 described in Example 1 were not used as compared with Example 1.

### (Configuration of Oil Synthesis Device)

Specifically, an oil synthesis device having the following components was used.
Starting material liquid passage part
   Main body part (material: PTFE, with additional supply port for the atmosphere/carbon dioxide (supply port diameter: φ1 mm))
   Inflow part for starting material liquid (material: PTFE, inflow diameter: R3/4 (20 A))
Starting material liquid

Sodium carbonate solution (obtained by dissolving 1.5 g/L of a sodium carbonate in 4 L of pure water)
Starting material liquid holding unit

Tank capable of holding the sodium carbonate solution
Pump unit

Pump NF3-250S with a flow rate of 28 L/min, manufactured by Kawamoto Pump Mfg. Co., Ltd.
Connection pipe

Material: PVC blade hose, diameter: φ19×φ26 mm

### (Additional Supply of Carbon Dioxide to Starting Material Liquid Passage Part)

The sodium carbonate solution in the tank was continuously supplied into the starting material liquid passage part at ambient temperature and ambient pressure using the pump. At the time of the continuous supply into the starting material liquid starting material liquid passage part, carbon dioxide was additionally supplied in an amount of 80 mL/min through the additional supply port of the starting material liquid passage part.

### (Measurement)

Thereafter, the solution (not subjected to plasma treatment) that had passed through the starting material liquid passage part was returned to the tank, and the solution in the tank was sampled, and subjected to quantitative analysis and qualitative analysis using a gas chromatography mass spectrometer (GC-MS-QP2010 Ultra manufactured by Shimadzu Corporation).

### (Results)

Measurement result 9

As shown in FIGS. 24 and 25, it was found that acetone was not detected at the starting material liquid passage part in any of the solution after the treatment for 30 minutes, the solution after the treatment for 60 minutes, and the solution before the start of the treatment. The temperature in the starting material liquid passage part on the day when the reaction was carried out was 25.2° C.

### (Discussion)

In view of Examples 1 to 4, it has been found that when a sodium carbonate solution (corresponding to a starting material liquid derived from carbon dioxide and water) is subjected to a plasma treatment in an electrode holding unit at ambient temperature and ambient pressure, it is possible to synthesize at least acetone as an oil. It is understood that the synthesis of such an oil is due to the bonding of the carbon, hydrogen, and oxygen sources in the sodium carbonate solution.

In addition, it has been found that when the atmospheric temperature during the plasma treatment is relatively low, specifically, about 22° C. or lower, it is also possible to synthesize ethanol (corresponding to an alcohol) in addition to acetone as an oil, as compared with Example 2. It is considered that the inter-electrode distance in the electrode holding unit is also related to the possibility of ethanol synthesis.

On the other hand, in view of Comparative Example 1, it has been found that an oil component such as acetone cannot be synthesized unless a sodium carbonate solution (corresponding to a starting material liquid derived from carbon dioxide and water) is subjected to a plasma treatment in a starting material liquid passage part at ambient temperature and ambient pressure (corresponding to the electrode holding unit in Examples 1 to 4).

Furthermore, in view of the measurement result 6 of Example 2, it has been found that acetone is generated at latest 1 minute after the start of the plasma treatment, and in addition, when the plasma treatment is performed for 5 minutes, the acetone concentration is about 3 to 4 times higher than that attained when the plasma treatment is performed for 30 minutes or more. Therefore, it has been found that the suitable plasma treatment time is 5 minutes.

From the above findings, it has been found that, according to the present invention, since a sodium carbonate solution having no risk of explosion at ambient temperature and ambient pressure is used, it is possible to improve energy efficiency and secure safety during operation of a synthesis device as compared with a conventional aspect in which hydrogen is used in combination under a high-temperature and high-pressure condition.

Aspects of the present invention are as follows.

<1>

An oil synthesis device comprising an electrode holding unit that can hold an electrode unit capable of generating plasma in a starting material liquid derived from both carbon dioxide and water and that is kept at ambient temperature and ambient pressure, wherein the oil synthesis device is capable of synthesizing an oil by the plasma from the starting material liquid located in the electrode holding unit.

<2>

The oil synthesis device according to <1>, wherein in the electrode holding unit, the starting material liquid can continuously pass through a region where the plasma is generated.

<3>

The oil synthesis device according to <1> or <2>, wherein at least a carbon source and a hydrogen source contained in the starting material liquid can be bonded by the plasma.

<4>

The oil synthesis device according to <3>, wherein a carbon source, a hydrogen source, and an oxygen source contained in the starting material liquid can be bonded by the plasma.

<5>

The oil synthesis device according to any one of <1> to <4>, wherein the starting material liquid is at least one selected from the group consisting of an aqueous alkali metal carbonate solution, an aqueous alkaline earth metal carbonate solution, and a gaseous carbon dioxide dissolved solution.

<6>

The oil synthesis device according to <5>, wherein the starting material liquid is a sodium carbonate solution.

<7>

The oil synthesis device of any one of <1> to <6>, wherein the oil is acetone.

<8>

The oil synthesis device of any one of <1> to <7>, wherein the oil is an alcohol.

<9>

The oil synthesis device of <8>, wherein the oil is ethanol.

<10>

The oil synthesis device according to any one of <1> to <9>, wherein at least one of an atmosphere and carbon dioxide can be supplied into the electrode holding unit.

<11>

The oil synthesis device according to any one of <1> to <10>, wherein the starting material liquid is brought into contact with the plasma for 1 minute or more and minutes or less.

<12>

The oil synthesis device according to <11>, wherein the starting material liquid is brought into contact with the plasma for 1 minute or more and 10 minutes or less.

<13>

The oil synthesis device according to any one of <1> to <12>, further comprising a starting material liquid holding unit capable of holding at least the starting material liquid.

<14>

The oil synthesis device according to <13>, further comprising a cooling unit capable of cooling the starting material liquid in the starting material liquid holding unit.

<15>

The oil synthesis device according to <13> or <14>, wherein the electrode holding unit and the starting material liquid holding unit are connected to each other with a pump unit interposed therebetween in such a manner that the starting material liquid can repeatedly pass through the electrode holding unit in one direction.

<16>

The oil synthesis device according to any one of <1> to <15>, further comprising a power supply capable of applying a voltage to the electrode unit.

<17>

The oil synthesis device according to any one of <1> to <16>, wherein no catalyst is made present in the electrode holding unit.

<18>

A method for synthesizing an oil, comprising applying a voltage to an electrode unit in an electrode holding unit that can hold therein the electrode unit and that is kept at ambient temperature and ambient pressure, generating plasma in a starting material liquid derived from both carbon dioxide and water located in the electrode holding unit, and synthesizing the oil from the starting material liquid.

<19>

The method according to <18>, wherein in the electrode holding unit, the starting material liquid is made to pass in one direction through a region where the plasma is generated.

<20>

The method according to <18> or <19>, wherein at least a carbon source and a hydrogen source contained in the starting material liquid are bonded by the plasma.

One embodiment of the present invention has been described above, but this is merely a typical example in the application range of the present invention. Therefore, a person skilled in the art may easily understand that the present invention is not limited thereto, and various modifications may be made.

### INDUSTRIAL APPLICABILITY

The oil synthesis device and the oil synthesis method according to one embodiment of the present invention can be suitably used for effective use of emitted carbon dioxide.

### CROSS-REFERENCE TO RELATED APPLICATION

The present application claims priority under the Paris Convention based on Japanese Patent Application No. 2022-185688 (Filing Date: Nov. 21, 2022, Title of Invention: “OIL SYNTHESIS DEVICE AND OIL SYNTHESIS METHOD”). The entire contents disclosed in the application are incorporated herein by reference.

### REFERENCE SIGNS LIST

100 Oil synthesis device
10 Electrode holding unit
11 Main body part of electrode holding unit
12 Inflow part for starting material liquid
13 Outflow part
14 Electrode unit
20 Starting material liquid
30 Starting material liquid holding unit
40 Pump unit
50 Connection pipe
60 Cooling unit

1. An oil synthesis device comprising:
an electrode holding unit that can hold therein an electrode unit capable of generating plasma in a starting material liquid derived from both carbon dioxide and water and that is kept at ambient temperature and ambient pressure, wherein the oil synthesis device is capable of synthesizing an oil by the plasma from the starting material liquid located in the electrode holding unit.

2. The oil synthesis device according to claim 1, wherein in the electrode holding unit, the starting material liquid can continuously pass through a region where the plasma is generated.

3. The oil synthesis device according to claim 1, wherein at least a carbon source and a hydrogen source contained in the starting material liquid can be bonded by the plasma.

4. The oil synthesis device according to claim 3, wherein a carbon source, a hydrogen source, and an oxygen source contained in the starting material liquid can be bonded by the plasma.

5. The oil synthesis device according to claim 1, wherein the starting material liquid is at least one selected from a group consisting of an aqueous alkali metal carbonate solution, an aqueous alkaline earth metal carbonate solution, and a gaseous carbon dioxide dissolved solution.

6. The oil synthesis device according to claim 5, wherein the starting material liquid is a sodium carbonate solution.

7. The oil synthesis device of claim 1, wherein the oil is acetone.

8. The oil synthesis device of claim 1, wherein the oil is an alcohol.

9. The oil synthesis device of claim 8, wherein the oil is ethanol.

10. The oil synthesis device according to claim 1, wherein at least one of an atmosphere and carbon dioxide can be supplied into the electrode holding unit.

11. The oil synthesis device according to claim 1, wherein the starting material liquid is brought into contact with the plasma for 1 minute or more and 60 minutes or less.

12. The oil synthesis device according to claim 11, wherein the starting material liquid is brought into contact with the plasma for 1 minute or more and 10 minutes or less.

13. The oil synthesis device according to claim 1, further comprising a starting material liquid holding unit capable of holding at least the starting material liquid.

14. The oil synthesis device according to claim 13, further comprising a cooling unit capable of cooling the starting material liquid in the starting material liquid holding unit.

15. The oil synthesis device according to claim 13, wherein the electrode holding unit and the starting material liquid holding unit are connected to each other with a pump unit interposed therebetween in such a manner that the starting material liquid can repeatedly pass through the electrode holding unit in one direction.

16. The oil synthesis device according to claim 1, further comprising a power supply capable of applying a voltage to the electrode unit.

17. The oil synthesis device according to claim 1, wherein no catalyst is made present in the electrode holding unit.

18. A method for synthesizing an oil, comprising:
applying a voltage to an electrode unit in an electrode holding unit that can hold therein the electrode unit and that is kept at ambient temperature and ambient pressure;
generating plasma in a starting material liquid derived from both carbon dioxide and water located in the electrode holding unit; and
synthesizing the oil from the starting material liquid.

19. The method according to claim 18, wherein in the electrode holding unit, the starting material liquid is made to continuously pass through a region where the plasma is generated.

20. The method according to claim 18, wherein at least a carbon source and a hydrogen source contained in the starting material liquid are bonded by the plasma.
